(19) United States
(12) Patent Application Publication
(10) Pub. No.: US 2009/0080314 A1
(43) Pub. Date: Mar. 26, 2009

(54) OPTICAL INFORMATION RECORDING/REPRODUCING APPARATUS AND ITS REPRODUCTION METHOD

(75) Inventors: KAZUKI MATSUMOTO, Kawasaki-shi (JP); Akiko Hirao, Kawasaki-shi (JP); Rumiko Hayase, Yokohama-shi (JP); Satoshi Mikoshiba, Yamato-shi (JP); Norikatsu Sasao, Tokyo (JP); Takahiro Kamikawa, Kawasaki-shi (JP); Masahiro Kanamaru, Fuchu-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/211,747

(22) Filed: Sep. 16, 2008

(30) Foreign Application Priority Data
Sep. 26, 2007 (JP) 2007-249502

(51) Int. Cl. G11B 7/00

(52) U.S. Cl. 369/103; G9B/7

(57) ABSTRACT

An optical recording/reproducing apparatus includes an optical recording medium in which a holograms are recorded depending on an incident angle of a reference beam. The reference beam is irradiated to holograms while changing the incident angle to generate a reproduction light beam, and an image patterns are detected by an image pattern detector. The continuously output reproduction image patterns are temporarily stored in an image recorder, and the maximum value of reproduction light intensity is detected to generate a trigger signal. Depending on the trigger signal, an optimal image pattern is extracted from continuous reproduction image patterns, and thus, two-dimensional data is decoded.

### CROSS-REFERENCE TO RELATED APPLICATIONS

This application is based upon and claims the benefit of priority from prior Japanese Patent Application No. 2007-249502, filed Sep. 26, 2007, the entire contents of which are incorporated herein by reference.

### BACKGROUND OF THE INVENTION

1. Field of the Invention

The present invention relates to holography, and in particularly to a holographic optical information recording/reproducing apparatus using digital volume holography.

2. Description of the Related Art

There has been known an optical information recorder as an information recorder capable of recording data having a large capacity such as a high-density image. Conventionally, a magneto-optical information recorder or apparatus such as optical phase-change information recorder and CD-R are practically used as the optical information recorder. However, requirements increase more and more with respect to high capacity of information recorded in an optical recording medium. In order to realize the foregoing high-capacity optical information recording, holography, in particular, a holographic optical information recording/reproducing apparatus using digital volume holography has been described in the following document.

Document: H. J. Coufal, D. Psaltis, and G. T. Sincerbox, Holographic Data Storage (Springer, 2000)

In general, an optical recording/reproducing apparatus using holography has a recording mode and a reproduction mode. In the recording mode, the apparatus makes interference between a signal beam having two-dimensional data and a reference beam in an optical recording medium to record the information as interference pattern. In the reproduction mode, the apparatus applies the reference beam to the recorded interference pattern. Then, the apparatus fetches information recorded as a diffraction image from the interference pattern to reproduce two-dimensional data. The optical recording/reproducing apparatus has merits capable of inputting and outputting high-capacity optical information at high speed. In particular, an optical recording/reproducing apparatus using digital volume holography aggressively utilizes a volume of the optical recording medium in a thickness direction to three-dimensionally record interference pattern as digital volume holography. Therefore, the optical recoding/reproducing apparatus of recording digital volume holography can improve diffraction efficiency, and enables multiple-recording in the same area of the optical recording medium. This serves to further increase a recording capacity.

The optical recording/reproducing apparatus using holography adds information to be recorded to the signal beam as two-dimensional data in the foregoing recording mode. Then, the apparatus makes interference of the signal beam and the reference beam in the recording medium to record information as interference pattern (hologram). In the reproduction mode, the apparatus irradiate the reference beam only to the recorded hologram in the same arrangement (angle) as the recording mode. In this way, the apparatus fetches information recorded as a diffraction image (pattern) from the hologram. In the reproduction mode, if the arrangement of the reference beam irradiated to the hologram (irradiation condition such as irradiation angle and position) is slightly shifted from the arrangement of the recording mode, the reference beam is irradiated to the recorded hologram; nevertheless, a phase between the reference beam and the hologram is not aligned; as a result, a diffraction image is not obtained. In the arrangement of the reference beam incapable of obtaining the diffraction image, interference pattern of another signal beam can be recorded. In this way, multiple-recording of plurality of two-dimensional data are possible in the same area of the optical recording medium in accordance with the arrangements of reference beams. Typically, there are angle multiple-recording, shift multiple-recording and phase code multiple-recording.

Photopolymer using a polymerization induced by optical pumping is strongly expected as a recording medium suitable to optical recording using holography. The photopolymer mainly consists of polymerizable monomers, a polymer holding volume and a photoinitiator for starting polymerization. According the recording mechanism, the photoinitiator is excited by a recording light beam, and then, the excited photoinitiator polymerizes polymerizable monomers nearly existing in a chain reaction. In this way, recording optical intensity distribution is converted to refractive index distribution (profile). Thus, even if a weak light beam is irradiated, a large change of refractive index is obtained. However, monomers polymerization is used; for this reason, a change of volume occurs during recording and after recording. As a result, the following matter has been known. Specifically, alignment of the reference beam with hologram disturbs in an information reproduction mode; for this reason, a reproduced image is degraded (see JP-A 2006-78922 (KOKAI)).

The following method has been proposed as a method of compensating the degradation of the reproduced image. According to the method, a plurality of reproduced images is acquired from on hologram, and thereafter, one sheet of reproduction image is synthesized (see Patent document 2). However, many reproduced images must be analyzed to select the original reproduced image of the systemization. For this reason, a large-capacity memory for temporarily holding the reproduced images is required. In addition, a large number of image processings must be repeated; for this reason, there is a problem that it is difficult to perform a reproduction speed at high speed.

### BRIEF SUMMARY OF THE INVENTION

According to one aspect of the invention, there is provided an optical recording/reproducing apparatus comprising:

a reference optical system which irradiates a reference beam onto an optical recording medium, a hologram being recorded in the optical recording medium depending on an incident angle of the reference beam, while changing the incident angle to generate a reproduction light beam from the hologram;

an image pattern detector which detects an image pattern in the reproduction light beam;

an image recorder which temporarily holds the reproduced image pattern continuously output from the image pattern detector;

a photo detector which detects a light intensity of the reproduction light beam to generate a detection signal;

a trigger generation circuit which detects the maximum value of the light intensity from the detection signal to generate a trigger signal; and

an image processor which extracts an optimal image pattern from the continuous reproduction images depending on the trigger signal, and decoding two-dimensional data from the optimal image pattern.

According to another aspect of the invention, there is provided an optical recording/reproducing method comprising:

irradiating a reference beam onto an optical recording medium, in which a hologram is recorded depending on an incident angle of the reference beam, while changing the incident angle to generate a reproduction light beam from the hologram;

continuously detecting image pattern in the reproduction light beam;

temporarily memorizing the detected reproduction image pattern;

continuously sensing a light intensity of the reproduction light beam, and detecting the maximum value of the light intensity to generate a trigger signal; and

extracting an optimal image pattern from the continuous reproduction images depending on the trigger signal, and decoding two-dimensional data from the optimal image pattern.

### BRIEF DESCRIPTION OF THE SEVERAL VIEWS OF THE DRAWING

FIG. 1 is a block diagram showing the configuration of a hologram optical recording/reproducing apparatus using volume holography according to one embodiment of the invention;

FIG. 2 is a flowchart showing a reproduction image procedure in the optical recording/reproducing apparatus shown in FIG. 1;

FIG. 3 is a block diagram showing configurations of an image recorder and a trigger generation circuit shown in FIG. 1;

FIG. 4A is a timing chart showing a change of an incident angle of a reference beam in the apparatus of FIG. 1;

FIG. 4B is a timing chart showing a detection signal processed in the trigger generation circuit shown in FIG. 1;

FIG. 4C is a timing chart showing transfer timing of image data transferred from an image acquisition unit to the image recorder shown in FIG. 1; and

FIG. 5 is a to plan view showing one example of an input image displayed on a reflection spatial light modulator in the optical recording/reproducing apparatus shown in FIG. 1.

### DETAILED DESCRIPTION OF THE INVENTION

A hologram optical information recording/reproducing apparatus using volume holography according to one embodiment of the invention will be described hereinafter with reference to the accompanying drawings.

The holography (hologram) of the hologram optical information recording/reproducing apparatus according to one embodiment of the invention is applicable to both of transmission holography (transmission hologram) and reflection holography (reflection hologram).

An optical information recording medium used for the optical recording/reproducing apparatus according to the invention typically has disc, card and block shapes. However, it is obvious that the optical information recording medium is not limited to these shapes described above.

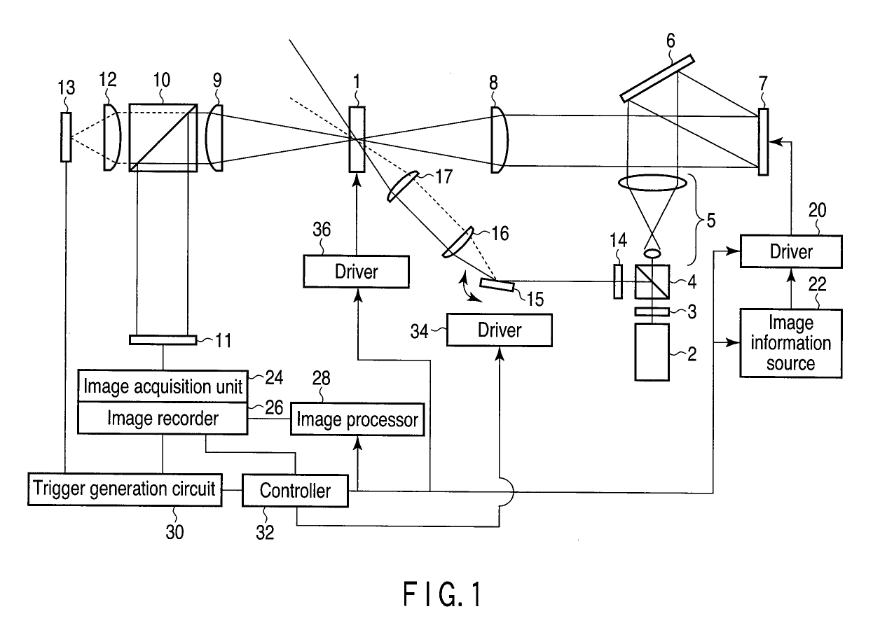

FIG. 1 shows the configuration of a hologram optical information recording/reproducing apparatus using volume holography according to one embodiment of the invention. The apparatus shown in FIG. 1 includes a light source 2. Preferably, a laser is used as the light source; specifically, a semiconductor laser, a He-Ne laser, an argon laser and a YAG laser are given. A light beam emitted from the light source 2 is incident on an optically rotating optical element 3 (polarizer), and then circularly polarized, and thereafter, sent to a polarization beam splitter 4. According to the polarization beam splitter 4, the incident light is divided into two beams, that is, light beams having different polarization component (P and S polarization components). A ½ or ¼ wavelength plate may be used as the optically rotating optical element 3.

The beam transmitted through the polarization beam splitter 4 is sent to a beam expander 5 as a signal beam. In the beam expander 5, the signal beam is expanded, and then, converted to a collimated beam, and thereafter, reflected from a mirror 6, and thus, irradiated to a reflection spatial light modulator 7. The reflection spatial light modulator 7 has a plurality of pixels, which are two-dimensionally arrayed like a lattice. The reflection spatial light modulator 7 comprises the following modulators. One is a modulator such as a digital mirror device (DMD), which can change the direction of a reflected light flux or beam from every pixel. Another is a modulator such as liquid crystal display (LCD), which can change the polarization direction of a reflected light beam emerged from every pixel. Image information to be recorded is supplied from an image information source 22 to a driver 20 so that the spatial light modulator 7 is operated according to an image signal from the driver 20. The spatial light modulator 7 generates a signal beam added with two-dimensional data as a recording light beam. In this case, the image information to be recorded means a pattern generated by giving digital data every pixel. Data to be recorded is converted to image information to be previously stored in the image information source 22. In the apparatus shown in FIG. 1, an optical system using a digital mirror device is shown as the reflection spatial light modulator 7.

When the collimated beam is incident on the reflection spatial light modulator 7, the beam is selectively reflected in areas corresponding to pixels. A signal beam having a spatially modulated pattern is reflected from the spatial light modulator 7 in accordance with image information. The signal beam is collected toward an optical recording medium 1 by an objective lens 8, and then, irradiated to a spot area on the optical recording medium 1 (spot-like volume area along the thickness direction of the optical recording medium).

Another beam reflected by the polarization beam splitter 4 is incident on an optically rotating optical element 14 as a reference beam. In the optically rotating optical element 14, a polarization plane is rotated to generate a light beam having the polarization component as the recording light beam so that the reference beam makes interference with the recording light beam. A ½ wavelength plate is mainly used as the optically rotating optical element 14. The reference beam transmitted through the optically rotating optical element 14 is incident on a galvanometer mirror 15 so that its irradiation direction is controlled, and then, sent to relay lenses 16 and 17. The reference beam sent to relay lenses 16 and 17 so that the reflection direction is controlled by the galvanometer mirror 15. In this way, an incident angle on the optical recording medium 1 is controlled. According to the foregoing incident angle control, the reference beam is irradiated to the same spot area as the area where the recording light beam on the optical recording medium 1 is irradiated (spot-like volume area along the thickness direction of the optical recording medium). The galvanometer mirror 15 is driven by a driver 34, and the angle of the reflection plane is controlled so that the reflection direction of the reference beam is specified. In this case, preferably, the driver 34 comprises a pulse motor. The galvanometer mirror 15 is intermittently driven so that the angle increases or decreases by a constant micro angle δ at a predetermined time interval Δt.

In the foregoing optical system, a reference beam optical system is called an optical system through which the reference beam sent from the light source 2 to the optical recording medium 1 transmits. The reference beam optical system is composed of galvanometer mirror 15, relay lenses 16 and 17 as is evident from the foregoing description. If an optical system fetching a reference beam from a single light source 2 is included, the reference beam optical system includes optically rotating optical element 3, polarization beam splitter 4 and optically rotating optical element 14 in addition to the foregoing galvanometer mirror 15, relay lenses 16 and 17. An optical system through which the recording light beam sent from the light source 2 to the optical recording medium 1 transmits is called a recording light beam optical system. The recording light beam optical system is composed of mirror 6, reflection spatial light modulator 7 and objective lens 8 in the narrow sense. In the wide sense, the recording light beam optical system includes optically rotating optical element 3 and polarization beam splitter 4 generating a signal beam as recording light beam from light beam from a single light source 2 in addition to the foregoing mirror 6, reflection spatial light modulator 7 and objective lens 8.

The signal beam and the reference beam are irradiated to the same spot area on the optical recording medium. In this way, a hologram is recorded on the spot area is recorded by interference of the foregoing two beams. In the recording mode, the incident angle of the reference beam is changed, and thereby, it is possible to realize angle multiple recording. According to the angle multiple recording, a hologram different from the hologram formed before the incident angle is changed is recorded in the same spot area.

In the apparatus shown in FIG. 1, the angle of the galvanometer mirror 15 is increased or decreased by a constant micro angle δ. With the foregoing angle change, the incident angle of the reference beam is increased or decreased by a micro angle Δα at time interval Δt. Incident angles of the reference beam α1, α2, . . . αn are set at a certain interval T integer times as much as the time interval Δt. Signal beams added with two-dimensional data are successively irradiated to the same spot area of the optical recording medium in accordance with the incident angles α1, α2, . . . αn. Therefore, n holograms reproducible at the incident angles α1, α2, . . . αn are formed in the same spot area. In this case, the incident angle of the reference beam is increased or decreased by integer times as much as the micro angle Δα at the time interval T when hologram is formed. When the reference beam reaches the incident angle α1, the signal beam is irradiated to the optical recording medium 1. Likewise, the incident angle of the reference beam is increased or decreased by integer times as much as the micro angle Δα until the reference beam reaches from the incident angle α1 to the incident angle α2. In this case, the driver 20 and the image information source 22 are controlled by the controller 32 so that they supply an image signal to the spatial light modulator 7 at the timing of the time interval T. The driver 34 driving the galvanometer mirror 15 is controlled by the controller 32, and the driver 34 gives a micro increase or decrease to the incident angle of the reference beam at the time interval Δt.

The driver 20 gives a synchronizing signal to the driver 34 before successively supplying n image signals to the spatial light modulator 7. While the n image signals are supplied, the drive 20 may be driven so that the galvanometer mirror 15 is continuously driven to give the continuously variable incident angles α1 to αn to the reference beam. According to the drive mechanism, interference of the reference beam with the signal beam is made at a specified angle of the incident angles α1 to an every when the signal beam including an image signal is irradiated to the optical recording medium 1. In this way, a hologram is formed.

In the reproduction mode of reproducing the recorded information, a reproduction beam is generated with respect to the recorded hologram in the following manner. Specifically, the reference beam is irradiated at the incident angles α1 to an in the recording mode to generate a hologram. The reference beam is irradiated to a hologram formed at a spot on the recording medium at the same incident angles α1 to an (determined in accordance with information to be read), and thus, a reproduction beam is generated. When transmitting through the hologram in the optical recording medium 1, the reference beam is diffracted more than the recorded hologram, and thus, a part of the reference light beam is reproduced as signal beam having the same pattern as the recording light beam. In this way, the part of the reference light beam is emitted from the hologram as a reproduction light beam. The reproduction light beam is emitted from the optical recording medium 1, and then, transmitted through a pickup lens 9, and thereafter, incident on a beam splitter 10. In the beam splitter 10, most of the reproduction light beam is reflected by the beam splitter 10, and then, imaged as a reproduction image (image pattern) on a two-dimensional photo detector 11 as an image pattern detector. The reproduction image (image pattern) is continuously output from the two-dimensional photo detector 11 as an image signal, and then, recorded in an image recorder 26. A plurality of image signals recorded in the image recorder 26 is analyzed by an image processor 28, and then, converted a clear reproduction image by image synthesizing processing. The image processor 28 decodes the obtained reproduction image signal to output it to an external circuit as a reproduction signal. In this case, the galvanometer mirror 15 is intermittently driven by the driver 34 in the reproduction mode to give a micro increase or decrease of the incident angle to the reference beam.

A part of the reproduction light beam transmitted through the beam splitter 10 is collected to a photo detector 13 via a lens 13. The photo detector 13 detects a light intensity of the reproduction light beam. A trigger generation circuit 30 detects the maximum position of the light intensity from a light intensity signal output from the photo detector 13. In response to the foregoing detection, the trigger generation circuit 30 generates a trigger signal. The controller 32 controls the driver 34 and the image acquisition unit 24 so that the driver 34 intermittently makes a micro shift of the angle of the galvanometer mirror 15. Therefore, the incident angle of the reference beam to the optical recording medium is continuously changed by a micro angle Δα. In accordance with the micro change Δα, many reproduction images acquired by the image acquisition unit 24 are successively supplied to the image recorder 26, and then, stored in the image recorder 26. When a predetermined sheet of reproduction images is continuously supplied from the image acquisition unit 24 t the image recorder 26, the trigger generation circuit 30 generates a trigger signal. In response to the trigger signal, a predetermined sheet of reproduction images is selected, and then, supplied from the image recorder 26 to the image processor 28. The reproduction image supplied to the image processor 28 is analyzed by the image processor 28, and then, converted to a vivid reproduction image by image synthesizing processing.

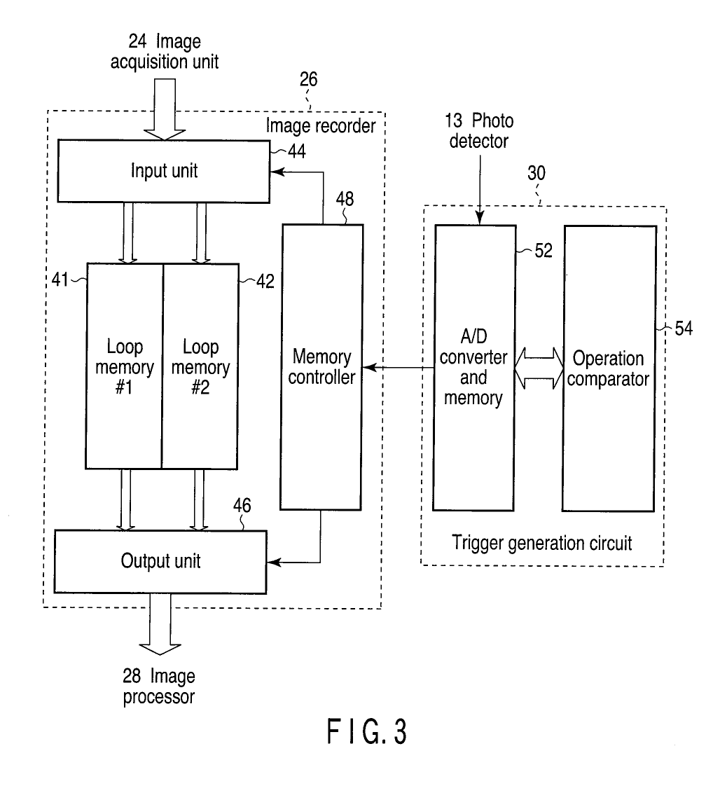

As shown in FIG. 3, the image processor 28 includes input unit 44, output units 46, and two loop memories 41 and 42. The input/output of image data (image signal) of the input and output units 44 and 46 is controlled by a memory controller 48. The foregoing two loop memories 41 and 42 stores image data input via the input and output units 44 and 46, and outputs the image data via the output unit 46. The trigger generation circuit 30 is composed of an A/D converter and memory 52 and an operation comparator 54. The A/D converter and memory 52 makes A/D conversion of the detection signal from the photo detector 13 to temporarily store the signal intensity. The operation comparator 54 makes a comparison operation of signal intensity.

The recording medium 1 may be rotated by the driver 36 so that the spot area is continuously updated. Or, the recording medium 1 may be linearly reciprocated so that the spot area is continuously updated. The driver 36 is controlled by the controller 32, and the spot area is stored in the image processor 28 as spot area position information. When the recording medium 1 is continuously driven, a sheet of hologram is recorded every when the light beam reaches a spot area in the recording mode. When the incident angles α1 to an are updated, a plurality of holograms is recorded on the same spot area. When the recording medium 1 is continuously driven, a sheet of hologram is read every when the light beam reaches a spot area in the reproduction mode. When the incident angles α1 to an are updated, n holograms are reproduced.

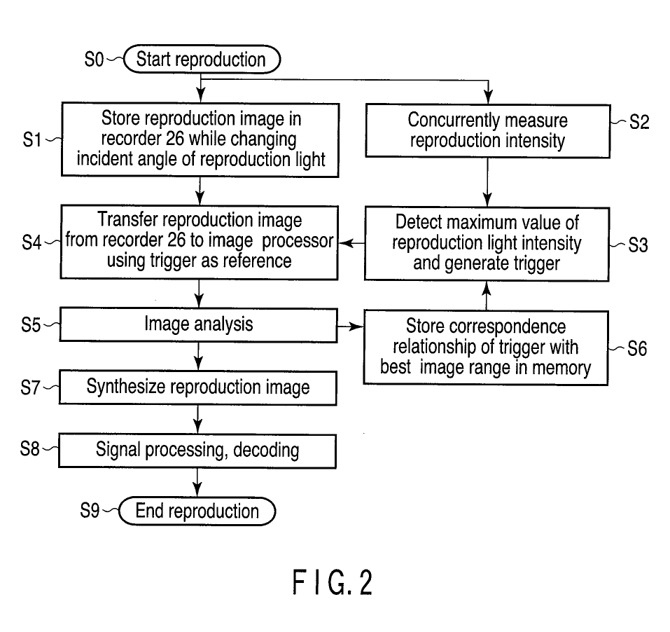

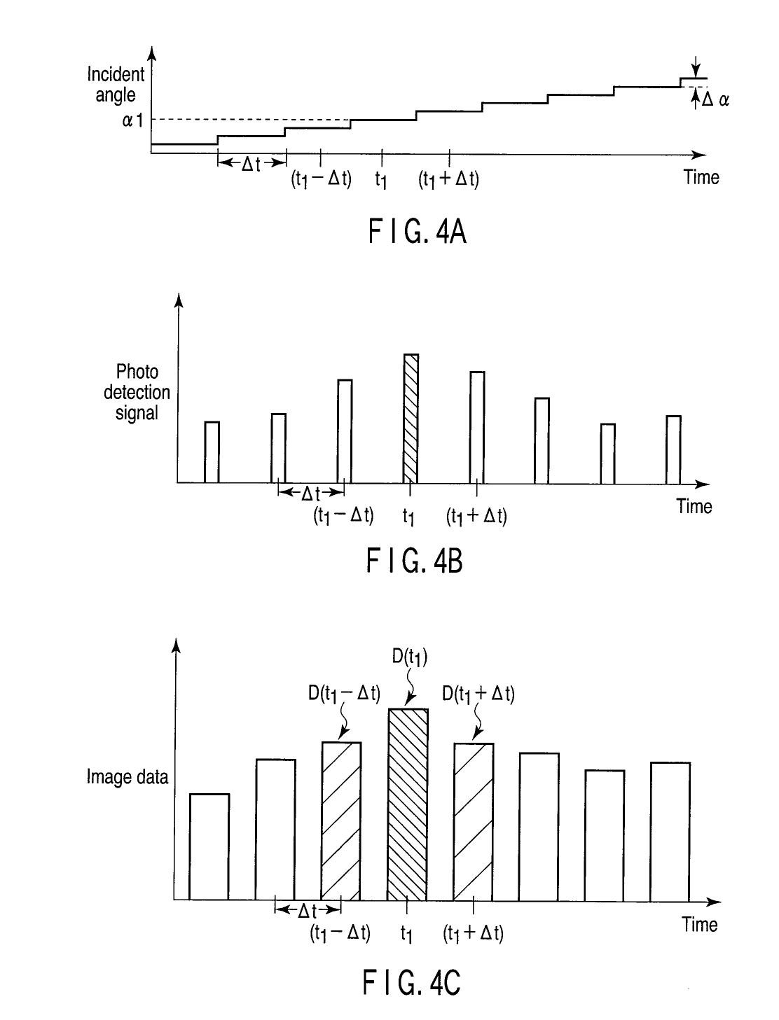

FIG. 2 is a flowchart to explain the procedure of reproducing an information reproduction image in the apparatus shown in FIG. 1. As shown in FIG. 2, in step S0, a reproduction mode of reproducing an information reproduction image is started. When the reproduction mode is started, the incident angle of the reference beam is intermittently changed by a micro angle Δα, and thereby, many reproduction images are successively stored in the image recorder 26. Specifically, as already described, the galvanometer mirror 36 is driven every time interval Δt, and thereby, the incident angle of the reference beam is increased by a micro angle Δα, as seen from FIG. 4A. In accordance with an increase of the incident angle, the photo detector 1 detects a part of a reproduction light beam as depicted in FIG. 4B. Then, the detected signal is input to the A/D converter and memory 52 of the trigger generation circuit 30 shown in FIG. 3 every the time interval Δt. Likewise, image data acquired by the image acquisition unit 24 every the time interval Δt is stored in the first loop memory 41 of the image recorder shown in FIG. 3 via the input unit 44.

The detection signal input to the A/D converter and memory 52 is converted from an analog signal to a digital signal, and thereafter, stored in the memory 52. According to the input time, the operation comparator 54 successively makes a comparison to detect the maximum value when the light intensity of the reproduction light beam reaches the maximum value.

According to the foregoing comparison, a timing t1 is set as a comparison reference. In this case, the following comparison targets are given. One is light intensity I(t1) at a timing t1. Another is light intensity I(t1−Δt) at timing (t1−Δt) before timing t1. Another is light intensity I(t1+Δt) at timing (t1+Δt) after timing t1. If the following relationship is established, the maximum value is determined. Specifically, a relation of light intensity I(t1−Δt)<light intensity I(t1) and light intensity I(t1)>light intensity I(t1+Δt) is established between light intensity I(t1), light intensity I(t1−Δt) and light intensity I(t1+Δt). From the foregoing relation, the light intensity I(t1) at timing t1 is determined as the maximum value. If the relationship is not established, it is determined that the light intensity of the maximum value is not detected at the timing t1. When the maximum value is determined, a trigger signal is supplied to the memory controller 48 from the A/D converter and memory 52. In this case, the timing t1 is given as address, and a trigger signal having the address is supplied to the memory controller 48.

In place of comparison of the light intensity at each timing, the operation comparator 54 operates an average value I(Av) of light intensity I(t1−Δt) and light intensity I(t1+Δt). A comparison is made between the average value I(Av) and light intensity I(t1), light intensity I(t1−Δt) and light intensity I(t1+Δt). If a relation of I(t1−Δt)<I(Av), I(t1)>I(Av) and I(t1+Δt)<I(Av) is established, it may be determined that the light intensity I(t1) at timing t1 is the maximum value.

If the foregoing condition is satisfied, and I(t1) is more than a predetermined threshold C, the light intensity I(t1) may be determined as the maximum value.

In the image recorder 26, image data are successively stored in the first loop memory 41 via the input unit 44 at timing (t1−Δt), timing t1 and timing (t1+Δt) . . . as shown in FIG. 4C. When the trigger signal is supplied to the memory controller 48, image data D(t1), D(t1−Δt) and D(t1+Δt) at timing t1, timing (t1−Δt) and timing (t1+Δt) before and after timing t1 are specified. When image data D(t1), D(t1−Δt) and D(t1+Δt) to be transferred are determined, the image data from t image acquisition unit 24 is supplied to the second loop memory 42 via the input unit 44 under the control of the memory controller 48. A switch from the first loop memory 41 to the second loop memory 42 is made, and thereby, transfer is prepared, and then, these image data D(t1), D(t1−Δt) and D(t1+Δt) are supplied to the image processor 48 in step S4.

The image data D(t1), D(t1−Δt) and D(t1+Δt) are analyzed by the image processor 28. The image processor 28 determines an image range suitable to information decoding in step S6 from histogram of image data D(t1), D(t1−Δt) and D(t1+Δt) transferred to the image recorder 26. In other words, the image data D(t1) is singly decodable, or the image range suitable to decoding is image data D(t1), D(t1−Δt) and D(t1+Δt). Thus, the image data D(t1), D(t1−Δt) and D(t1+Δt) are processed to acquire the optimal image. A optimal selection range of the image with respect to the trigger signal is stored in memory together with timing appended with the trigger signal. In this case, the timing has the correspondence relation with an incident angle α1 of the reference beam as already described. The foregoing timing is equivalent to the optimal timing for reproducing the same hologram in the next time; therefore, referred when the same hologram is again reproduced.

Based on the image analysis in step 5, the best image is output using single image data in step S7, or a reproduction image included in many image data is synthesized to generate one best reproduction image and to output it. Thereafter, in step S8, the best image is processed to be converted to an image signal. The image signal is decoded, and then, output as decoding data. In step S9, a series of procedure ends.

If another hologram is formed on the same spot area, the same procedure as above is carried out, and thereby, the reproduction image is supplied together with trigger signal generation timing data equivalent to the optimal incident angle α2, and then, stored in the memory of the image processor 28. Thus, the same procedure as above is carried out, and thereby, n best images are output. The trigger signal generation timing equivalent to the optimal incident angle α1 to an the optimal timing is determined. Simultaneously, an acquisition range of the best image to the trigger signal generation timing is determined, and then, stored in the memory of the image processor 28. The trigger signal generation timing is stored in the memory together with recording position information o the recording medium 1, that is, position address of the spot area where hologram on the recording medium 1 is formed.

The optical system of the apparatus shown in FIG. 1 is configured into a transmission holography (transmission hologram) optical system such that the reference beam transmits through the recording medium 1 as the recording medium 1. In this case, the optical system may be configured into a reflection holography (reflection hologram) optical system having a reflection layer, and that the reproduction light beam is reflected from the recording medium 1 as the recording medium 1. According to the reflection holography (reflection hologram) optical system, the optical system detecting the reproduction light beam is arranged along the optical path of the reproduction light beam reflected from the recording medium 1. Specifically, the pickup lens 9, the beam splitter 10 and the two-dimensional photo detector 11 are arranged along the optical path of the reproduction light beam. In addition, the lens 12 and the photo detector 13 may be arranged along the optical path of a light beam transmitted through the beam splitter 10.

### EMBODIMENT

One embodiment of a hologram optical recording/reproducing apparatus according to the invention will be hereinafter described.

### <Production of Optical Recording Medium>

According to the embodiment of the hologram optical recording/reproducing apparatus, an optical recording medium 1 was produced in the following procedure.

Vinylcarbazole of 4.8 g, vinylpyrolidone, and Irgacure 784 of 0.15 (made by Chiba Specialty Chemicals Company) were added, and then, agitated to prepare a monomer solution A. Thereafter, 1.4-butanediol diglicygil ether of 10.1 g and diethylene triamine of 3.6 g were mixed to prepare an epoxy solution B. Then, the monomer solution of 1.5 ml and the epoxy solution of 8.5 ml were mixed, and thereafter, deformed to prepare an optical recording medium precursor.

A fluororesin spacer having a thickness of 250 μm was placed on a main surface of a glass substrate (50 mm*50 mm*0.5 mm), and then, the foregoing obtained mixed solution was cast during this time. After cast, an independently prepared glass substrate (50 mm*50 mm*0.5 mm) was arranged in a state of facing the foregoing glass substrate. A pressure was applied, and thereby, the foregoing mixed solution was pressed to have a thickness of 250 μm. finally, the resultant was heated at 50° C. for ten hours to prepare a disc-like optical recording medium 1 including a recording area having a thickness of 250 μm. The foregoing work was done in a room so that light shorter than a wavelength 600 nm was shielded.

<Optical Recording/Reproducing Apparatus>

The optical recording/reproducing apparatus comprises the optical system shown in FIG. 1. A nitrogen gallium semiconductor laser device (wavelength: 405 nm) is used as the light source. A digital mirror device is used as the reflection spatial light modulator 7. A CCD is used as the two-dimensional photo detector 11. A photodiode is used as the photo detector 1.

The signal recorder 26 is stored with images using a program (loop memory program) of loop-recording an image output from the CCD as virtual loop memories 41 and 42. The program includes the procedure of simultaneously recording two output images in two memory areas with respect to array storing image information. The trigger generation circuit 30 is virtually set, and captures an output from the photodiode 13 in a computer (operation unit 54). The circuit 30 detects the maximum value of the reproduction light intensity according to a program (trigger program) to send a trigger signal to a loop memory program. The loop memory program receiving the trigger signal stops recording of image information to one array of two arrays storing image information. The circuit 30 transfers a designated sheet of reproduction images before and after the trigger signal to an image processing program. According to the image processing program, an image range suitable for decoding information is determined from histogram of the transferred reproduction image, and thus, the information is decoded. The image range suitable to decoding determined according to the image processing program is feedback to the loop memory program, and thus, an image selection range with respect to the trigger signal is optimized.

<Recording of Information>

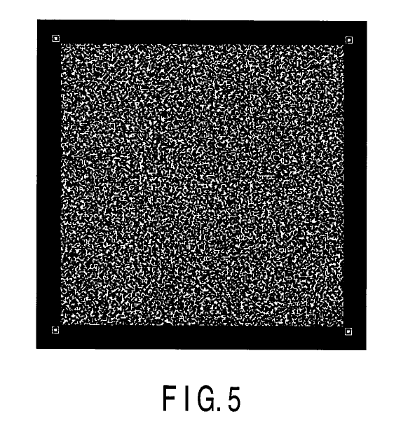

An input image shown in FIG. 5 is displayed on the digital mirror device 7. The center 256×256 pixel area is used an information optical area. 16 pixels (neighboring 4×4) is used as one unit, and a modulation method using eight pixels of 16 pixels as a light point is employed. According to light intensity on the surface of the optical medium 1, information light is 0.1 mW, and reference light 0.2 nW. A spot size of the laser beam is as follows. The information light has a diameter of 2 mm, and the reference light ha a diameter of 3 mm. According to multiple recording, the angle of the reference light is changed at intervals of one degree with respect to the perpendiculars of the optical recording medium from 30 to 70 degree. In this way, 41 holograms equivalent to 41 page images are formed according angle multiple recording. The exposure time is controlled so that diffraction efficiency from each hologram becomes 1%. After hologram is recorded, the entire surface exposure is carried out with respect to the optical recording medium using a light emitting diode (wavelength: 405 nm) to consume non-reaction component. The dose of the entire exposure is set to about 5 J/cm².

<Reproduction of Information>

Reproduction of the optical recording medium 1 recording information is carried out in the following method. The reference light is scanned at the interval of 0.05 degree with respect to the perpendiculars of the optical recording medium in an angle range from 29 to 71 degree. In this way, the reproduction image obtained by the CCD 11 is successively recorded in the loop memory program. Based on the output of the photodiode 13, trigger is generated in the trigger program. Then, the reproduction image recorded in the loop memory program is transferred to the image processing program. Range initialization of image transfer to the trigger signal is set to ten images before and after trigger is generated. The image range suitable to decoding determined by the image processing program is fed back, and thereby, the range is reduced. As a result, when 41-page holograms are reproduced without an error, the sheet of reproduction images sent to the image processor is 225.

<Reproduction of Information>

### Comparative Example

Reproduction was carried out in the following method as a comparison with respect to the embodiment of the present invention. The same optical recording medium as above was used as an optical recording medium. The reference light was scanned at the interval of 0.05 degree in a constant range of angle position (from 30 to 70 at the interval of 1 degree) before and after the angle of the reference light.

Then, the reproduction image obtained by the CCD 11 was transferred to the image processing program. The scan range of the reference light is changed from ±0.5 degree to ±0.1 degree, and thereafter, a change of the output from the image processing program was checked. As a result, the scan range of the reference light having no error was ±0.3 degree. In this case, the sheet of reproduction images sent to the image processor was 533 to reproduce 4-page holograms.

As described above, the optical recording/reproducing apparatus using holography, specifically, digital volume holography includes a loop-like image memory. The image memory continuously acquires reproduction images, and stores then in a state of being overwritten. The reproduction image is acquired, and concurrently, the maximum value of reproduction light intensity is detected to generate a trigger. Based on the generated trigger, event trigger processing is carried out. According to the event trigger processing, the reproduction image in a predetermined range on the loop image memory is transferred to the image reproduction unit. Therefore, the number of image processing times is largely reduced as compared with the conventional method of transferring many reproduction images to the image processor. Thus, reproduction is realized at high speed. In addition, the capacity of the recorder temporarily holding reproduction images is reduced, and thus, the apparatus is simplified.

As described above, in the hologram optical recording/reproducing apparatus using holography, specifically, volume holography, the number of image processing times is largely reduced, and reproduction is realized at high speed. In addition, the capacity of the recorder temporarily holding reproduction images is reduced, and thus, the apparatus is simplified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical recording/reproducing apparatus comprising:
a reference optical system irradiating a reference beam onto holograms recorded in the optical recording medium depending on an incident angle of the reference beam, while changing the incident angle;
an image pattern detector detecting reproduction image patterns in the reproduction light beam;
an image recorder temporarily storing reproduction image patterns continuously output from the image pattern detector;
a photo detector detecting a light intensity of the reproduction light beam to generate a detection signal;
a trigger generation circuit detecting the maximum value of the light intensity from the detection signal to generate a trigger signal; and
an image processor extracting an optimal image pattern from continuous reproduction image patterns depending on the trigger signal, and decoding two-dimensional data from the optimal image pattern.

2. The apparatus according to claim 1, wherein reproduction image patterns are continuously transferred to the image processor to extract the optimal image pattern from continuous reproduction image patterns, reproduction image patterns being obtained during a time period between before and after the generation timing of the trigger signal.

3. The apparatus according to claim 1, wherein the image recorder temporarily stores reproduction image patterns in continuous loop, and overwriting reproduction image patterns with new reproduction image pattern output from the image pattern detector.

4. The apparatus according to claim 1, wherein the image recorder includes:
first and second recording areas temporarily storing reproduction image patterns in continuous loop;
an input unit selectively receiving reproduction image patterns to the first and second recording area;
an output unit selectively transferring reproduction image patterns from the first and second recording area; and
a controlling unit controlling the input and output units in response to the trigger signal to selectively receiving reproduction image patterns to the first and second recording areas, and selectively transferring reproduction image patterns from the first and second recording areas.

5. An optical recording/reproducing method comprising:
irradiating a reference beam onto an optical recording medium, in which holograms are recorded depending on an incident angle of the reference beam, while changing the incident angle;
continuously detecting reproduction image patterns in the reproduction light beam;
temporarily memorizing detected reproduction image patterns;
continuously sensing a light intensity of the reproduction light beam, and detecting the maximum value of the light intensity to generate a trigger signal; and
extracting an optimal image pattern from continuous reproduction image patterns depending on the trigger signal, and decoding two-dimensional data from the optimal image pattern.

6. The method according to claim 5, wherein the decoding includes transferring reproduction image patterns in a predetermined range obtained between before and after a generation timing of the trigger signal to extract an optimal image pattern, and decoding two-dimensional data from the optimal image pattern.

7. The method according to claim 5, wherein the memorizing includes temporarily storing reproduction image patterns in continuous loop, overwriting reproduction image patterns with new reproduction image pattern.
